(19) United States
(12) Patent Application Publication
(10) Pub. No.: US 2026/0288403 A1
(43) Pub. Date: Sep. 24, 2026

(54) INFORMATION PROCESSING DEVICE, METHOD, AND NON-TRANSITORY RECORDING MEDIUM FOR REDUCING OPERATION BURDEN ON USER

(71) Applicant: NEC Corporation, Tokyo (JP)

(72) Inventors: Sayo MINOWA, Tokyo (JP); Yusuke Mori, Tokyo (JP); Yu Tsumuraya, Tokyo (JP); Masatoshi Furukawa, Tokyo (JP); Akio Yoshioka, Tokyo (JP)

(21) Appl. No.: 19/558,687

(22) Filed: Mar. 6, 2026

(30) Foreign Application Priority Data
Mar. 19, 2025 (JP) 2025-044675

(51) Int. Cl. G06F 3/14; G06F 3/01

(52) U.S. Cl. CPC G06F 3/14; G06F 3/012; G06F 3/013; G06F 3/017

(57) ABSTRACT

An information processing device according to the present disclosure accepts a request to display an application window from a user wearing a head mounted display, automatically determines, based on a type of an application operated through the application window, a display mode of the application window to be either a first mode in which the application window is displayed at a fixed position in a virtual space of the head mounted display or a second mode in which the application window is displayed at a fixed position on a screen of the head mounted display, and displays the application window in the determined display mode.

### INCORPORATION BY REFERENCE

This application is based upon and claims the benefit of priority from Japanese patent application No. 2025-44675, filed on Mar. 19, 2025, the disclosure of which is incorporated herein in its entirety by reference.

### TECHNICAL FIELD

The present disclosure relates to an information processing device, a method, and a non-transitory recording medium.

### BACKGROUND ART

JP 2024-538557 W discloses a technology in which an electronic device (for example, a head mounted display) arranges a user interface of an application in a three-dimensional space and displays the three-dimensional space from a viewpoint of a user of the electronic device.

### SUMMARY

In the technology according to JP 2024-538557 W, it is necessary to manually set a display mode of an application window which is a user interface of an application in a head mounted display (HMD). Therefore, there is a problem that the operation burden on the user in the HMD is imposed on the user, such as the user's operation in the HMD becomes complicated.

In view of such problems, an example object of the present disclosure is to provide an information processing device, a method, and a non-transitory recording medium capable of reducing an operation burden on a user.

An information processing device according to an example aspect of the present disclosure comprises:
at least one memory configured to store instructions; and
at least one processor configured to execute the instructions to:
accept a request to display an application window from a user wearing a head mounted display;
automatically determine, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
display the application window in the determined display mode.

A computer implemented method according to an example aspect of the present disclosure comprises:
an acceptance process of accepting a request to display an application window from a user wearing a head mounted display;
a determination process of automatically determining, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
a display control process of displaying the application window in the determined display mode.

A non-transitory recording medium according to an example aspect of the present disclosure stores a program. The program causes a computer to execute:
an acceptance process of accepting a request to display an application window from a user wearing a head mounted display;
a determination process of automatically determining, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
a display control process of displaying the application window in the determined display mode.

According to the present disclosure, it is possible to provide an information processing device, a method, and a non-transitory recording medium capable of reducing an operation burden on a user.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating an example of a configuration of an information processing device 10 according to the present disclosure;

FIG. 2 is a block diagram illustrating an example of a configuration of an information processing device 20 according to the present disclosure;

FIG. 3 is a schematic diagram illustrating an example of a difference between a first mode and a second mode which are display modes of an application window in the information processing device 20 according to the present disclosure;

FIG. 4 is a flowchart illustrating an example of an operation of the information processing device 20 according to the present disclosure;

FIG. 5 is a block diagram illustrating an example of a configuration of an information processing device 30 according to the present disclosure;

FIG. 6 is a flowchart illustrating an example of an operation of the information processing device 30 according to the present disclosure;

FIG. 7 is a flowchart illustrating an example of an operation of an information processing device 40 according to the present disclosure;

FIG. 8 is a block diagram illustrating an example of a configuration of an information processing device 50 according to the present disclosure;

FIG. 9 is a flowchart illustrating an example of an operation of the information processing device 50 according to the present disclosure; and

FIG. 10 is a block diagram illustrating an example of a configuration of a computer 1000 according to the present disclosure.

### EXAMPLE EMBODIMENTS

Hereinafter, example embodiments according to the present disclosure will be described in detail with reference to the drawings. In the drawings, the same or related elements are denoted by the same reference numerals, and repeated description is omitted as necessary for clarity of description.

### First Exemplary Example Embodiment

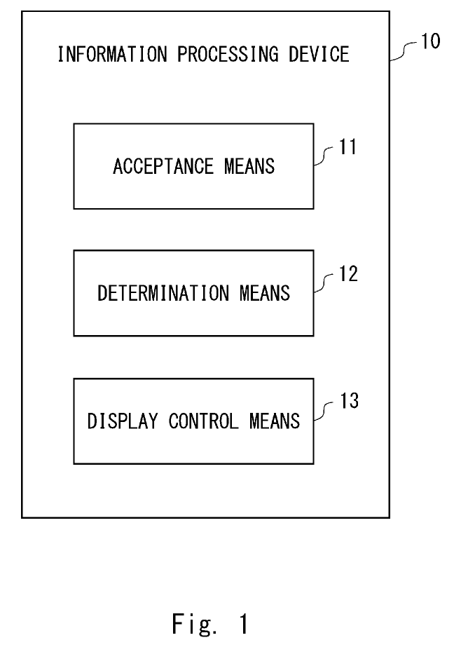

First, a configuration of an information processing device 10 according to a first exemplary example embodiment will be described with reference to FIG. 1.

FIG. 1 is a block diagram illustrating an example of a configuration of the information processing device 10 according to the present disclosure. As illustrated in FIG. 1, the information processing device 10 includes an acceptance means 11, a determination means 12, and a display control means 13.

The acceptance means 11 accepts a request to display an application window from the user wearing an HMD. The determination means 12 automatically determines the display mode of the application window to be either a first mode in which the application window is displayed at a fixed position in the virtual space of the HMD or a second mode in which the application window is displayed at a fixed position on the screen of the HMD based on the type of the application operated through the application window. The display control means 13 executes control to display the application window in the determined display mode.

The information processing device 10 according to the present disclosure automatically determines an optimal display mode of an application window for operating an application according to a type of the application. Therefore, in the information processing device 10, the user does not need to manually determine the display mode of the application window. By doing so, the information processing device 10 can reduce the operation burden on the user in the HMD.

### Second Exemplary Example Embodiment

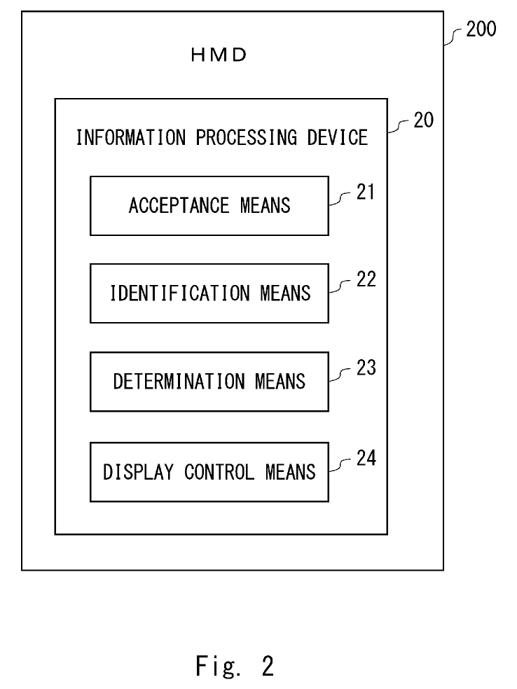

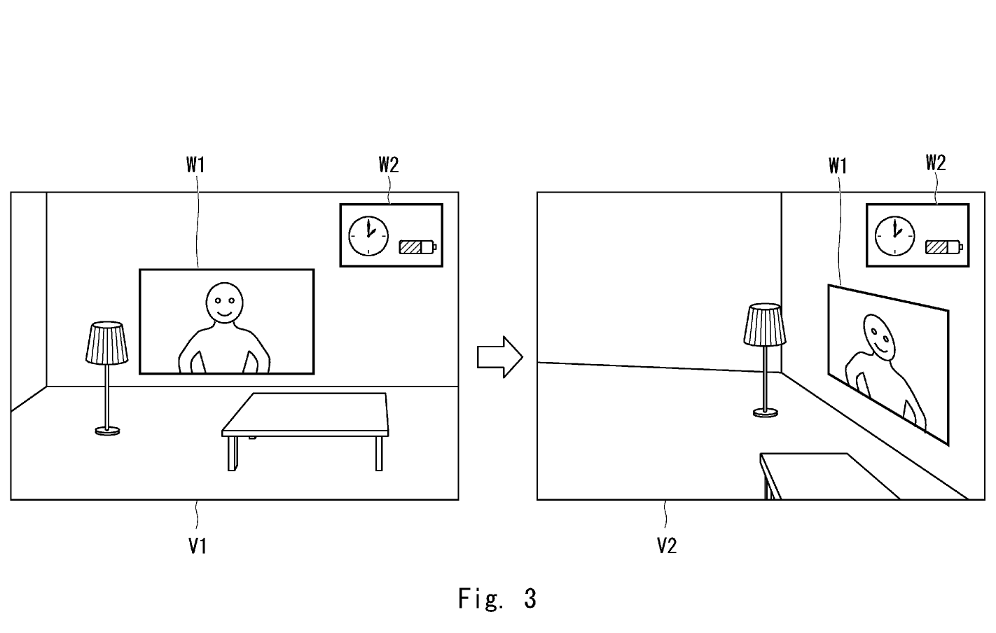

Next, a configuration of an information processing device 20 according to a second exemplary example embodiment will be described with reference to FIGS. 2 and 3. The information processing device 20 embodies the information processing device 10.

FIG. 2 is a block diagram illustrating an example of a configuration of the information processing device 20 according to the present disclosure. As illustrated in FIG. 2, the information processing device 20 is mounted on an HMD 200. The information processing device 20 may be a part of the function of the HMD 200. The information processing device 20 may be arranged outside the HMD 200. In a case where the information processing device 20 is arranged outside the HMD 200, the information processing device communicates with the HMD 200 via a network. The network is, for example, a wide area network (WAN), a local area network (LAN), or a short-distance wireless network.

The function and the like of the HMD 200 will be outlined. The HMD 200 is a virtual reality device or an augmented reality device that seamlessly achieves fusion between the real world and virtual digital content. The high definition display is mounted on the goggles of the HMD 200, and three-dimensional digital content can be superimposed and displayed in the real world visually recognized by the user.

The HMD 200 displays video on the left and right displays in the goggles. The user can perform stereoscopic space recognition by the left and right images. The HMD 200 includes a video camera installed so as to be capable of capturing the viewing direction of the user, and adopts a video see-through method of displaying digital content in superposition with a video captured in real time by the video camera. Note that the HMD 200 may include a single display instead of the left and right displays in the goggles, and may display video on the single display.

In the HMD 200, an operating system (OS) is installed similarly to a smartphone or the like. Furthermore, an application that operates on the OS is installed in the HMD 200.

For example, icons related to various settings and icons for starting installed applications, which are digital content created by the HMD 200, are superimposed and displayed on a video of the real world captured by the video camera.

The HMD 200 includes a camera capable of capturing the user's eyes (pupil, iris), and is configured to be able to detect the line of sight of the user (the wearer of the HMD 200). The HMD 200 includes a camera capable of capturing an image of a user's finger or the like, and is configured to be able to detect a gesture by the user's finger. The HMD 200 receives a request from the user for the OS or the application of the HMD 200 by detecting the user's line of sight or gesture.

The user can operate the OS or the application of the HMD 200 by a line of sight or a gesture. For example, the user can start the application of the HMD 200 by a line of sight or a gesture and change the display position of the application window. The user can operate the OS or the application of the HMD 200 by voice.

The HMD 200 photographs a real space viewed from the viewpoint of the user wearing the HMD 200 with a camera mounted on the HMD 200. The HMD 200 displays the captured real space as a virtual space in the field of view of the user. In other words, the field of view of the user is the screen of the HMD 200.

Hereinafter, a case may be assumed in which the user can move while wearing the HMD 200 and viewing the application window displayed on the screen of the HMD 200. Here, the application window is a user interface for operating the application.

The information processing device 20 is a computer. The information processing device 20 includes an acceptance means 21, an identification means 22, a determination means 23, and a display control means 24. Here, the acceptance means 21, the determination means 23, and the display control means 24 of the information processing device 20 are relevant to the acceptance means 11, the determination means 12, and the display control means 13 of the information processing device 10 according to the first exemplary example embodiment.

The acceptance means 21 accepts a request to display an application window from the user wearing the HMD 200. The acceptance means 21 may accept a request to start an application operated through the application window instead of the request to display the application window.

The identification means 22 identifies the type of the application operated through the application window requested to be displayed.

The determination means 23 automatically determines the display mode of the application window to be either the first mode or the second mode based on the identified type of the application. The first mode is a display mode in which the application window is displayed at a fixed position in the virtual space of the HMD 200. The second mode is a display mode in which the application window is displayed at a fixed position on the screen of the HMD 200.

The determination means 23 sets the display mode of the application window to the first mode in a case where the identified application is an application (in the following, a first application) that the user is not recommended to view while moving from a safety viewpoint or the like. The first application includes, for example, at least one of a video application and a web browser. On the other hand, the determination means 23 sets the display mode of the application window to the second mode in a case where the identified application is an application (in the following, a second application) whose convenience is improved in a case where the user moves and views the application. The second application includes, for example, at least one of an application that displays basic information such as a remaining battery level and time, an application that presents map information, a recipe during cooking, and the like, and an application that displays spot information at a tourist spot for a user who is touring.

Next, a difference between the first mode and the second mode which are display modes of the application window in the information processing device 20 will be described with reference to FIG. 3.

FIG. 3 is a schematic diagram illustrating an example of a difference between the first mode and the second mode which are display modes of an application window in the information processing device 20 according to the present disclosure. In FIG. 3, the screen of the HMD 200 is indicated by V1 and V2. The screen V2 is a screen of the HMD 200 after the user viewing the screen V1 faces left.

The application windows displayed on the screen of the HMD 200 are denoted by W1 and W2. The application window W1 is an application window for operating a video application. The display mode of the application window W1 is set to a first display mode in which the application window W1 is displayed at a fixed position in the virtual space displayed on the screen V1 and the screen V2. On the other hand, the application window W2 is an application window for operating an application that displays basic information such as remaining battery level and time. The display mode of the application window W2 is set to a second display mode in which the application window W2 is displayed at a fixed position on the screen V1 and the screen V2.

In a case where the screen of the HMD 200 changes from V1 to V2, the position of the application window W1 viewed from the user changes. On the other hand, the position of the application window W2 viewed from the user does not change even in a case where the screen of the HMD 200 changes from V1 to V2.

The description returns to FIG. 2. The determination means 23 refers to a table in which the type of the application is associated with the display mode of the application window, and automatically determines the display mode of the application window based on the identified type of the application. The determination means 23 may access the identified application and acquire information designating the display mode of the application window from the application. Then, the determination means 23 may automatically determine the display mode of the application window based on the acquired information designating the display mode.

The determination means 23 may be able to set in advance, for each application, whether to set the display mode of the application window to the first mode or the second mode at the time of activation of the application based on a request of the user.

The display control means 24 executes control to display the application window in one of the determined display modes of the first mode and the second mode. Then, the display control means 24 receives a request to close the application window from the user. In the case of accepting the request, the display control means 24 executes control to close the displayed application window.

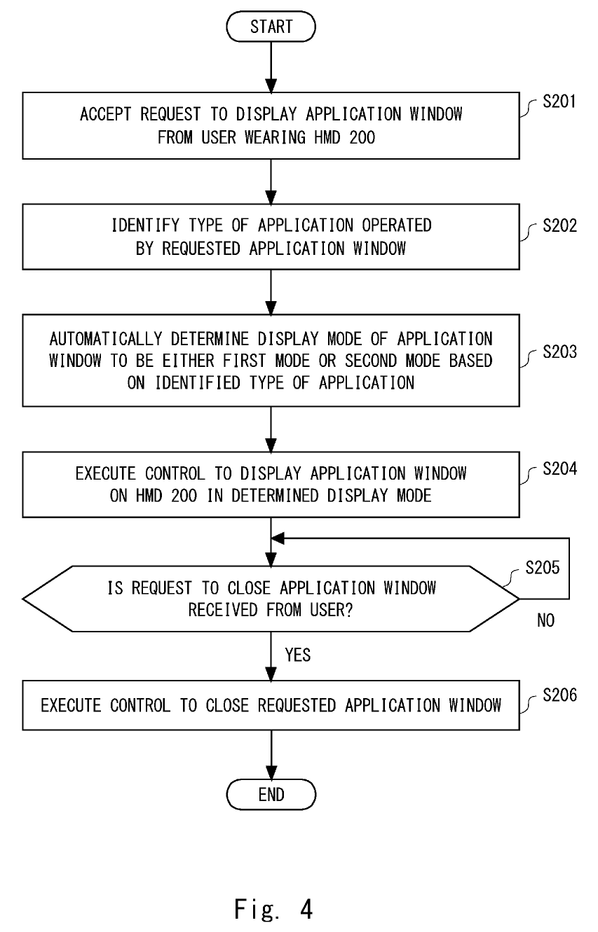

Next, an operation of the information processing device 20 according to the second exemplary example embodiment will be described with reference to FIG. 4.

FIG. 4 is a flowchart illustrating an example of an operation of the information processing device 20 according to the present disclosure. As illustrated in FIG. 4, in step S201, the acceptance means 21 of the information processing device 20 accepts a request to display an application window from the user wearing the HMD 200. Next, in step S202, the identification means 22 identifies the type of the application operated through the requested application window.

Next, in step S203, the determination means 23 automatically determines the display mode of the application window to be either the first mode or the second mode based on the identified type of the application. Next, in step S204, the display control means 24 executes control to display the application window on the HMD 200 in the determined display mode.

The information processing device 20 may repeat the processing of steps S201 to S204 and execute control to display a plurality of application windows on the HMD 200.

Next, in step S205, the display control means 24 determines whether a request to close the application window has been accepted from the user. In a case where it is determined that the request to close the application window has been received from the user (YES in step S205), the process proceeds to step S206. On the other hand, in a case where it is determined that the request to close the application window from the user has not been accepted (NO in step S205), the process returns to step S205. Next, in step S206, the display control means 24 executes control to close the requested application window.

As described above, the information processing device 20 according to the present disclosure automatically determines an optimal display mode of an application window for operating an application according to a type of the application. Therefore, in the information processing device 20, the user does not need to manually determine the display mode of the application window. By doing so, the information processing device 20 can reduce the operation burden on the user in the HMD 200. Furthermore, since the operation burden can be reduced, the information processing device 20 can improve the work efficiency of the user in the VR space.

### Third Exemplary Example Embodiment

In the HMD, there is room for improvement in providing a user with a comfortable VR experience. An object of an information processing device 30 according to the present disclosure is to solve such a problem.

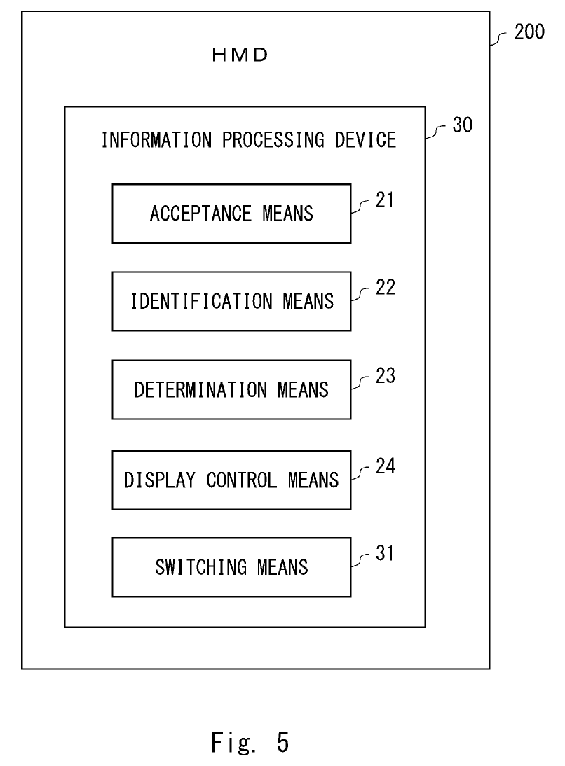

First, a configuration of an information processing device 30 according to a third exemplary example embodiment will be described with reference to FIG. 5. FIG. 5 is a block diagram illustrating an example of a configuration of the information processing device 30 according to the present disclosure. As illustrated in FIG. 5, the information processing device 30 is mounted on the HMD 200 similarly to the information processing device 20 (see FIG. 2) according to the second exemplary example embodiment described above. The information processing device 30 may be a part of the function of the HMD 200. The information processing device 30 may be arranged outside the HMD 200. In a case where the information processing device 30 is arranged outside the HMD 200, the information processing device communicates with the HMD 200 via a network. The information processing device 30 further includes a switching means 31 in addition to the components (acceptance means 21, identification means 22, determination means 23, and display control means 24) of the information processing device 20 described above. The display control means 24 further has the following functions.

The switching means 31 switches the display mode of the application window displayed on the HMD 200 according to at least one of the motion and the situation of the user. Here, the switching means 31 switches the display mode of the application window between the first mode and the second mode. The display control means 24 executes control to display the application window in the display mode switched by the switching means 31.

Specifically, the switching means 31 and the display control means 24 have at least one of the following functions (a) to (d).
(a) For example, in a case where the HMD 200 detects a preset gesture by the user (for example, an operation in which the user taps the thumb and the index finger three times), the switching means 31 switches the display mode of the application window. Then, the display control means 24 executes control to display the application window in the switched display mode.
(b) For example, in a case where the HMD 200 detects a preset operation on an application window by the user (for example, an operation by the user to select a thumbtack icon displayed on the application window), the switching means 31 switches the display mode of the application window. Then, the display control means 24 executes control to display the application window in the switched display mode.
(c) For example, in a case where the HMD 200 detects a preset change in the display position of the application window, the switching means 31 switches the display mode of the application window. Then, the display control means 24 executes control to display the application window in the switched display mode. At this time, the display control means 24 displays the switched application window at the changed display position.

For example, in a case where the HMD 200 detects that the application window displayed in the first mode is moved from the position in front of the field of view to the position in the upper right of the field of view by the user, the switching means 31 switches the display mode from the first mode to the second mode. At this time, the display control means 24 executes control to display the application window switched to the second mode at the upper right position of the field of view. In a case where the HMD 200 detects that the application window displayed in the second mode is moved from the upper right position of the field of view to the front position of the field of view by the user, the switching means 31 switches the display mode from the second mode to the first mode. At this time, the display control means 24 executes control to display the application window switched to the first mode at the front position of the field of view.
(d) In a case where the HMD 200 detects a preset change in the position information of the HMD 200, the switching means 31 switches the display mode of the application window. Here, the change in the position information of the HMD 200 is detected from, for example, measurement information of a GPS sensor (not illustrated) mounted on the HMD 200. Then, the display control means 24 executes control to display the application window in the switched display mode.

For example, in a case where the position of the HMD 200 exits from a predetermined area while the application window is displayed in the first mode, the switching means 31 switches the display mode from the first mode to the second mode. Then, the display control means 24 executes control to display the application window in the switched display mode. In a case where the position of the HMD 200 enters a predetermined area while the application window is displayed in the second mode, the switching means 31 switches the display mode from the second mode to the first mode. Then, the display control means 24 executes control to display the application window in the switched display mode.

In a more detailed example, it is assumed that a user wearing the HMD 200 is talking in a living room while viewing an application window of a video call displayed in the first mode at a fixed position (for example, in front of a sofa) in a virtual space included in the field of view of the user. Then, in a case where the user leaves the living room and moves along the corridor toward a different room while making a call, the switching means 31 switches the display mode of the application window from the first mode to the second mode. While the user is moving, the display control means 24 executes control to display the application window at a fixed position (for example, upper right) on the field of view of the user. Further, in a case where the user arrives at another room, the switching means 31 switches the display mode of the application window from the second mode to the first mode again. Then, the display control means 24 displays the application window at a fixed position (for example, on a desk) in the virtual space included in the field of view of the user.

The functions (a) to (d) have been described above. In addition, the display control means 24 may automatically set at least one of the display position of the application window and the display size of the application window based on the type of the application identified by the identification means 22. For example, the display control means 24 displays an application window of an application indicating map information in a small size on the upper right of the field of view of the user in the second mode. Thereafter, the switching means 31 switches the display mode of the application window from the second mode to the first mode according to at least one of the motion and the situation of the user. In this case, the display control means 24 may display the application window in a large size in front of the field of view of the user.

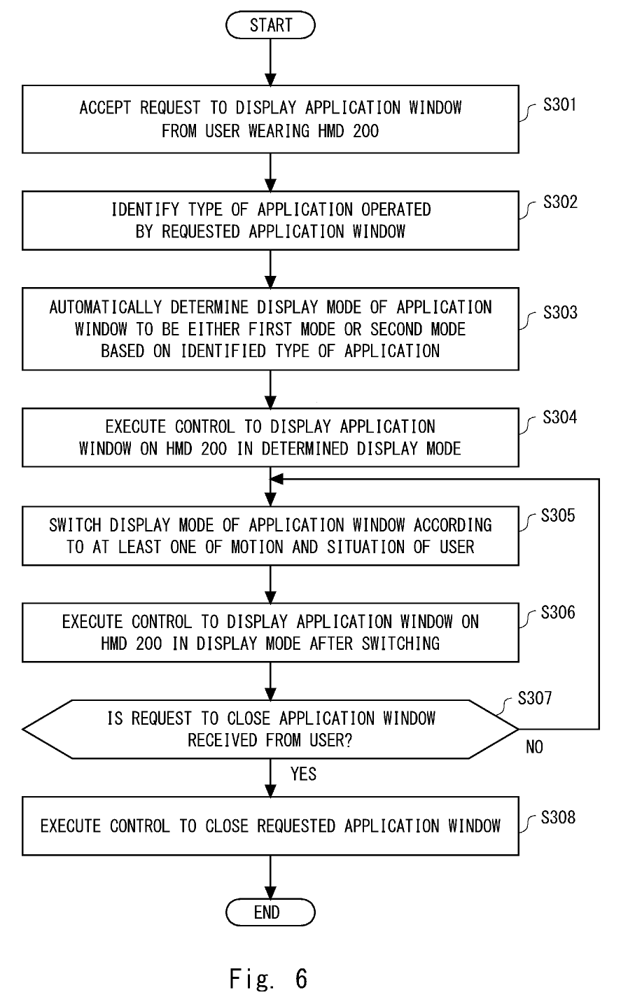

Next, an operation of the information processing device 30 according to a third exemplary example embodiment will be described with reference to FIG. 6.

FIG. 6 is a flowchart illustrating an example of an operation of the information processing device 30 according to the present disclosure. As illustrated in FIG. 6, in step S301, the acceptance means 21 of the information processing device 30 accepts a request to display an application window from the user wearing the HMD 200. Next, in step S302, the identification means 22 identifies the type of the application operated through the requested application window.

Next, in step S303, the determination means 23 automatically determines the display mode of the application window to be either the first mode or the second mode based on the identified type of the application. Next, in step S304, the display control means 24 executes control to display the application window on the HMD 200 in the determined display mode.

Next, in step S305, the switching means 31 switches the display mode of the application window according to at least one of the motion and the situation of the user. Next, in step S306, the display control means 24 executes control to display the application window in the display mode after switching.

Next, in step S307, the display control means 24 determines whether a request to close the application window has been accepted from the user. In a case where it is determined that a request to close the displayed application window has been accepted from the user (YES in step S307), the process proceeds to step S308. On the other hand, in a case where it is determined that the request to close the displayed application window has not been accepted from the user (NO in step S307), the process returns to step S305. In step S308, the display control means 24 executes control to close the requested application window.

The information processing device 30 according to the present disclosure can automatically switch the display mode in accordance with at least one of the motion and the situation of the user. Therefore, the information processing device 30 can provide the user with a more comfortable VR experience.

### Fourth Exemplary Example Embodiment

There is a problem that the field of view of the user may be obstructed by the application window being always displayed in the field of view of the user in the second mode (that is, a mode of displaying the application window at a fixed position on the screen of the HMD 200). An object of an information processing device 40 according to a fourth exemplary example embodiment is to solve such a problem.

First, a configuration of an information processing device 40 (not illustrated) according to the fourth exemplary example embodiment will be described. The information processing device 40 is mounted on the HMD 200 similarly to the information processing device 20 (see FIG. 2) according to the second exemplary example embodiment described above. The information processing device 40 may be a part of the function of the HMD 200. The information processing device 40 may be arranged outside the HMD 200. In a case where the information processing device 40 is arranged outside the HMD 200, the information processing device communicates with the HMD 200 via a network. The information processing device 40 includes components (acceptance means 21, identification means 22, determination means 23, and display control means 24) similar to those of the information processing device 20 described above. However, the display control means 24 of the information processing device 40 further has the following functions as compared with the information processing device 20.

In a case where the display mode of the application window displayed on the HMD 200 is the second mode, the display control means 24 detects the state of the user wearing the HMD 200 based on the acceleration information of the HMD 200. Here, the acceleration information of the HMD 200 is, for example, measurement information of an acceleration sensor (not illustrated) mounted on the HMD 200. The detected state of the user is, for example, whether the user is walking or stationary.

The display control means 24 automatically adjusts the transparency of the displayed application window based on the detected state of the user. For example, in a case where the user is walking, the display control means 24 sets the transparency of the displayed application window to be higher than that in a case where the user is stationary. By doing so, the display control means 24 can ensure the visibility during movement of the user.

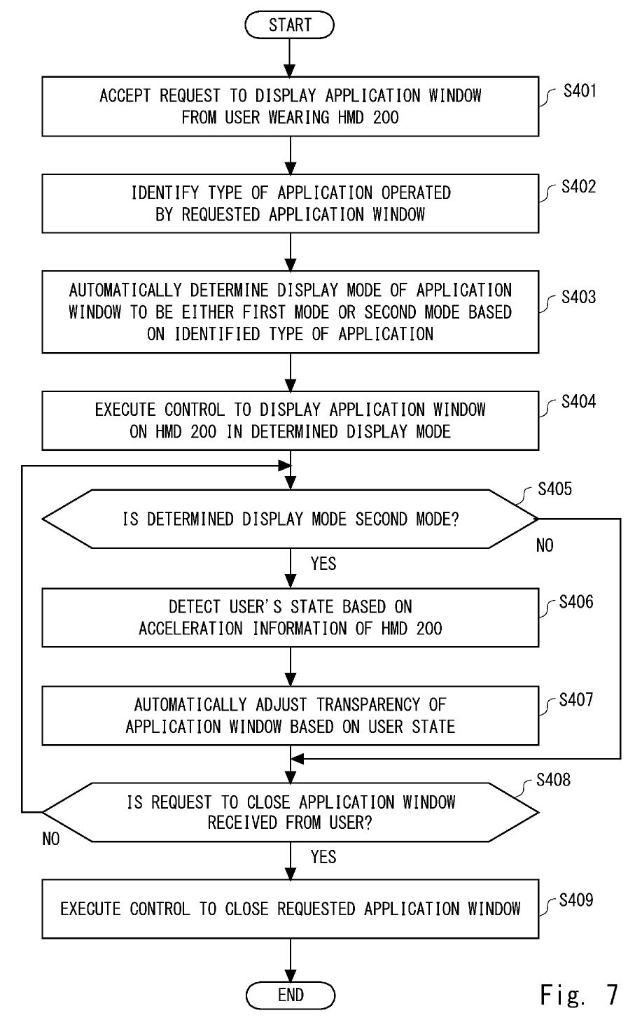

Next, an operation of the information processing device 40 according to the fourth exemplary example embodiment will be described with reference to FIG. 7.

FIG. 7 is a flowchart illustrating an example of an operation of the information processing device 40 according to the present disclosure. As illustrated in FIG. 7, in step S401, the acceptance means 21 of the information processing device 40 accepts a request to display an application window from the user wearing the HMD 200. Next, in step S402, the identification means 22 identifies the type of the application operated through the requested application window.

Next, in step S403, the determination means 23 automatically determines the display mode of the application window to be either the first mode or the second mode based on the identified type of the application. Next, in step S404, the display control means 24 executes control to display the application window on the HMD 200 in the determined display mode.

Next, in step S405, the display control means 24 determines whether the determined display mode is the second mode. In a case where it is determined that the determined display mode is the second mode (YES in step S405), the process proceeds to step S406. On the other hand, in a case where it is determined that the determined display mode is not the second mode (NO in step S405), the process proceeds to step S408.

In step S406, the display control means 24 of the information processing device 40 detects the state of the user wearing the HMD 200 based on the acceleration information of the HMD 200. Next, in step S407, the display control means 24 automatically adjusts the transparency of the application window based on the detected state of the user.

Next, in step S408, the display control means 24 determines whether a request to close the application window has been accepted from the user. In a case where it is determined that a request to close the displayed application window has been accepted from the user (YES in step S408), the process proceeds to step S409. On the other hand, in a case where it is determined that the request to close the displayed application window has not been accepted from the user (NO in step S408), the process returns to step S405. In step S409, the display control means 24 executes control to close the requested application window.

In a case where the application window is displayed in the second mode, the information processing device 40 according to the present disclosure automatically adjusts transparency of the displayed application window based on the detected state of the user. By doing so, the information processing device 40 can reduce the possibility that the field of view of the user is obstructed.

### Fifth Exemplary Example Embodiment

In a case where a plurality of application windows are displayed in the HMD 200, switching of display modes of the plurality of application windows simultaneously occurs, which may obstruct the field of view of the user. An object of an information processing device 50 according to a fifth exemplary example embodiment is to solve such a problem.

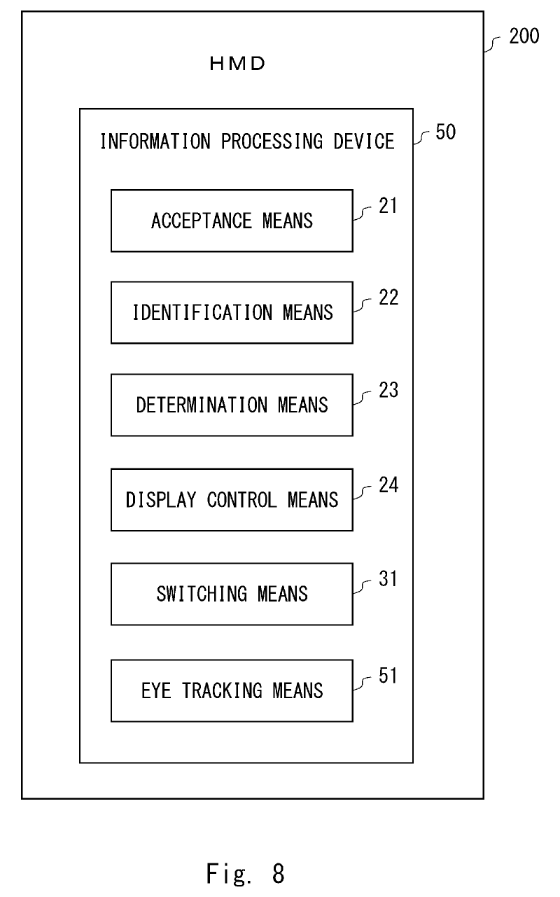

First, a configuration of the information processing device 50 according to the fifth exemplary example embodiment will be described with reference to FIG. 8. FIG. 8 is a block diagram illustrating an example of a configuration of the information processing device 50 according to the present disclosure. As illustrated in FIG. 8, the information processing device 50 is mounted on the HMD 200 similarly to the information processing device 30 (see FIG. 5) according to the third exemplary example embodiment described above. The information processing device 50 may be a part of the function of the HMD 200. The information processing device 50 may be arranged outside the HMD 200. In a case where the information processing device 50 is arranged outside the HMD 200, the information processing device communicates with the HMD 200 via a network. As compared with the information processing device 30 described above, the information processing device 50 further includes an eye tracking means 51 in addition to the components (acceptance means 21, identification means 22, determination means 23, display control means 24, and switching means 31) of the information processing device 30. The switching means 31 further has the following functions.

The eye tracking means 51 tracks the line of sight of the user wearing the HMD 200. Here, the line of sight of the user is tracked from an image including the eyes of the user wearing the HMD 200 captured by, for example, a camera (not illustrated) mounted on the HMD 200.

In a case where a plurality of application windows are displayed on the HMD 200, the switching means 31 specifies an application window visually recognized by the user from the plurality of displayed application windows based on the tracked line of sight of the user. The switching means 31 switches the display mode of the specified application window.

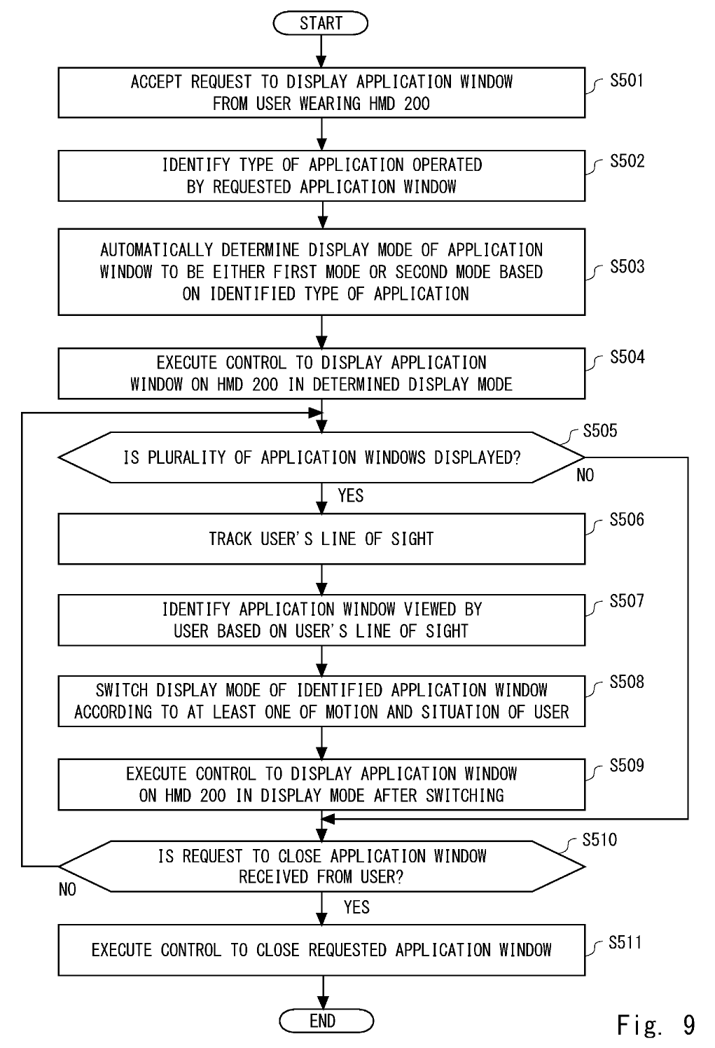

Next, an operation of the information processing device 50 according to the fifth exemplary example embodiment will be described with reference to FIG. 9.

FIG. 9 is a flowchart illustrating an example of an operation of the information processing device 50 according to the present disclosure. As illustrated in FIG. 9, in step S501, the acceptance means 21 of the information processing device 40 accepts a request to display an application window from the user wearing the HMD 200. Next, in step S502, the identification means 22 identifies the type of the application operated through the requested application window.

Next, in step S503, the determination means 23 automatically determines the display mode of the application window to be either the first mode or the second mode based on the identified type of the application. Next, in step S504, the display control means 24 executes control to display the application window on the HMD 200 in the determined display mode. The information processing device 50 may repeat the processing of steps S501 to S504 and execute control to display a plurality of application windows on the HMD 200.

Next, in step S505, the display control means 24 determines whether a plurality of application windows are displayed on the HMD 200. In a case where it is determined that a plurality of application windows are displayed on the HMD 200 (YES in step S505), the process proceeds to step S506. On the other hand, in a case where it is determined that the plurality of application windows are not displayed on the HMD 200 (NO in step S505), the process proceeds to step S510.

In step S506, the eye tracking means 51 tracks the line of sight of the user. Next, in step S507, the switching means 31 specifies an application window visually recognized by the user from the plurality of displayed application windows based on the tracked line of sight of the user.

Next, in step S508, the switching means 31 switches the display mode of the specified application window based on at least one of the motion and the situation of the user. Next, in step S509, the switching means 31 executes control to display the application window on the HMD 200 in the display mode after switching.

Next, in step S510, the display control means 24 determines whether a request to close the application window has been accepted from the user. In a case where it is determined that a request to close the displayed application window has been accepted from the user (YES in step S510), the process proceeds to step S511. On the other hand, in a case where it is determined that the request to close the displayed application window has not been accepted from the user (NO in step S510), the process returns to step S505. In step S511, the display control means 24 executes control to close the requested application window.

In a case where a plurality of application windows are displayed, the information processing device 50 according to the present disclosure executes switching of a display mode for an application window visually recognized by a user. By doing so, the information processing device 50 can reduce the possibility that the field of view of the user is obstructed.

The present invention is not limited to the above example embodiments, and can be appropriately changed without departing from the scope.

### Hardware Configuration

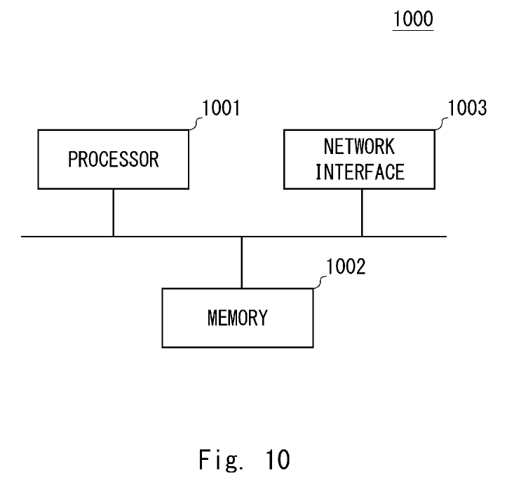

FIG. 10 is a block diagram illustrating an example of a configuration of a computer 1000 according to the present disclosure. The information processing device 10, the information processing device 20, the information processing device 30, the information processing device 40, and the information processing device 50 described above are implemented by the computer 1000. As illustrated in FIG. 10, the computer 1000 includes a processor 1001, a memory 1002, and a network interface 1003. The network interface 1003 may be used to communicate with network nodes. The network interface 1003 may include, for example, a network interface card (NIC) conforming to IEEE 802.3 series. IEEE represents Institute of Electrical and Electronics Engineers.

The processor 1001 reads one or a plurality of programs including instructions for causing a computer to perform the algorithm (method) described with reference to the drawings from the memory 1002 and executes the read programs. The processor 1001 may be, for example, a microprocessor, a micro processing unit (MPU), or a central processing unit (CPU). The processor 1001 may include a plurality of processors.

The memory 1002 is configured by a combination of a volatile memory and a nonvolatile memory. The memory 1002 stores a program. The memory 1002 may include a storage disposed away from the processor 1001. In this case, the processor 1001 may access the memory 1002 via an Input/Output (I/O) interface (not illustrated).

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The present disclosure provides a specific information display method using a VR technology, and is not merely an abstract idea. In particular, it has specific technical features such as automatic mode determination according to the type of application and mode switching according to the operation and situation of the user.

Further, in examples in the manufacturing industry, a specific technical effect of improving work efficiency and accuracy is produced by automatic mode switching according to a work process. This is a technical solution that improves the conventional manufacturing process, and is not merely an organization of human activities. A display position optimization function by eye tracking is a specific technical feature that contributes to improvement of a user interface, and provides a new technical solution by integration of a computer technology and a VR technology. From these points, the present invention is considered to be a patentable invention that satisfies the requirements of Section 101 of the U.S. Patent Law.

Some or all of the above-described example embodiments may be described as the following Supplementary Notes, but are not limited to the following.

### Supplementary Note 1

An information processing device comprising:
at least one memory configured to store instructions; and
at least one processor configured to execute the instructions to:
accept a request to display an application window from a user wearing a head mounted display;
automatically determine, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
display the application window in the determined display mode.

### Supplementary Note 2

The information processing device according to Supplementary Note 1, wherein the at least one processor is configured to execute the instructions to:
switch a display mode of the application window according to at least one of a motion and a situation of the user; and
display, after a display mode of the application window is switched, the application window in a display mode after the switching.

### Supplementary Note 3

The information processing device according to Supplementary Note 2, wherein the at least one processor is configured to execute the instructions to switch a display mode of the application window in a case where at least one of a preset gesture by the user, a preset predetermined operation on the application window by the user, a preset change in a display position of the application window, and a preset change in position information of the head mounted display is detected.

### Supplementary Note 4

The information processing device according to Supplementary Note 1, wherein the at least one processor is configured to execute the instructions to automatically set at least one of a display position of the application window and a display size of the application window based on a type of the application.

### Supplementary Note 5

The information processing device according to Supplementary Note 1, wherein the at least one processor is configured to execute the instructions to:
detect a state of the user based on acceleration information of the head mounted display in a case where the display mode is the second mode; and
automatically adjust transparency of the application window based on the detected user state.

### Supplementary Note 6

The information processing device according to Supplementary Note 2, wherein the at least one processor is configured to execute the instructions to:
track a line of sight of the user; and
identify, in a case where a plurality of the application windows are displayed, an application window viewed by the user from the plurality of displayed application windows based on the tracked line of sight of the user, and switch a display mode of the identified application window.

### Supplementary Note 7

A computer implemented method comprising:
an acceptance process of accepting a request to display an application window from a user wearing a head mounted display;
a determination process of automatically determining, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
a display control process of displaying the application window in the determined display mode.

### Supplementary Note 8

The method according to Supplementary Note 7, further comprising a switching process of switching a display mode of the application window according to at least one of a motion and a situation of the user,
wherein the display control process includes displaying, after a display mode of the application window is switched, the application window in a display mode after the switching.

### Supplementary Note 9

The method according to Supplementary Note 8, wherein the switching process includes switching a display mode of the application window in a case where at least one of a preset gesture by the user, a preset predetermined operation on the application window by the user, a preset change in a display position of the application window, and a preset change in position information of the head mounted display is detected.

### Supplementary Note 10

The method according to Supplementary Note 7, wherein the display control process includes automatically setting at least one of a display position of the application window and a display size of the application window based on a type of the application.

### Supplementary Note 11

The method according to Supplementary Note 7, wherein the display control process includes:
detecting a state of the user based on acceleration information of the head mounted display in a case where the display mode is the second mode; and
automatically adjusting transparency of the application window based on the detected user state.

### Supplementary Note 12

The method according to Supplementary Note 8, further comprising an eye tracking process of tracking a line of sight of the user,
wherein the switching process includes:
determining, in a case where a plurality of the application windows are displayed, an application window that the user is viewing from the plurality of displayed application windows based on the tracked line of sight of the user; and
switching display modes of the determined application window.

### Supplementary Note 13

A non-transitory recording medium storing a program for causing a computer to execute:
an acceptance process of accepting a request to display an application window from a user wearing a head mounted display;
a determination process of automatically determining, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
a display control process of displaying the application window in the determined display mode.

Some or all of the elements (e.g., configurations and functions) described in Supplementary Notes 2 to 6 dependent on Supplementary Note 1 can also be dependent on each of Supplementary Notes 13 by the same dependency relationship as Supplementary Notes 2 to 6. Some or all of the elements described in any Supplementary Note may be applied to various types of hardware, software, recording means for recording software, systems, and methods.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

What is claimed is:

1. An information processing device comprising:
at least one memory configured to store instructions; and
at least one processor configured to execute the instructions to:
accept a request to display an application window from a user wearing a head mounted display;
automatically determine, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
display the application window in the determined display mode.

2. The information processing device according to claim 1, wherein the at least one processor is configured to execute the instructions to:
switch a display mode of the application window according to at least one of a motion and a situation of the user; and
display, after a display mode of the application window is switched, the application window in a display mode after the switching.

3. The information processing device according to claim 2, wherein the at least one processor is configured to execute the instructions to switch a display mode of the application window in a case where at least one of a preset gesture by the user, a preset predetermined operation on the application window by the user, a preset change in a display position of the application window, and a preset change in position information of the head mounted display is detected.

4. The information processing device according to claim 1, wherein the at least one processor is configured to execute the instructions to automatically set at least one of a display position of the application window and a display size of the application window based on a type of the application.

5. The information processing device according to claim 1, wherein the at least one processor is configured to execute the instructions to:
detect a state of the user based on acceleration information of the head mounted display in a case where the display mode is the second mode; and
automatically adjust transparency of the application window based on the detected user state.

6. The information processing device according to claim 2, wherein the at least one processor is configured to execute the instructions to:
track a line of sight of the user; and
identify, in a case where a plurality of the application windows are displayed, an application window viewed by the user from the plurality of displayed application windows based on the tracked line of sight of the user, and switch a display mode of the identified application window.

7. A computer implemented method comprising:
an acceptance process of accepting a request to display an application window from a user wearing a head mounted display;
a determination process of automatically determining, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
a display control process of displaying the application window in the determined display mode.

8. The method according to claim 7, further comprising a switching process of switching a display mode of the application window according to at least one of a motion and a situation of the user,
wherein the display control process includes displaying, after a display mode of the application window is switched, the application window in a display mode after the switching.

9. The method according to claim 8, wherein the switching process includes switching a display mode of the application window in a case where at least one of a preset gesture by the user, a preset predetermined operation on the application window by the user, a preset change in a display position of the application window, and a preset change in position information of the head mounted display is detected.

10. The method according to claim 7, wherein the display control process includes automatically setting at least one of a display position of the application window and a display size of the application window based on a type of the application.

11. The method according to claim 7, wherein the display control process includes:
detecting a state of the user based on acceleration information of the head mounted display in a case where the display mode is the second mode; and
automatically adjusting transparency of the application window based on the detected user state.

12. The method according to claim 8, further comprising an eye tracking process of tracking a line of sight of the user,
wherein the switching process includes:
determining, in a case where a plurality of the application windows are displayed, an application window that the user is viewing from the plurality of displayed application windows based on the tracked line of sight of the user; and
switching display modes of the determined application window.

13. A non-transitory recording medium storing a program for causing a computer to execute:
an acceptance process of accepting a request to display an application window from a user wearing a head mounted display;
a determination process of automatically determining, based on a type of an application operated through the application window, a display mode of the application window to be either a first mode in which the application window is displayed at a fixed position in a virtual space of the head mounted display or a second mode in which the application window is displayed at a fixed position on a screen of the head mounted display; and
a display control process of displaying the application window in the determined display mode.
